(19) United States
(12) Patent Application Publication
(10) Pub. No.: US 2006/0279584 A1
(43) Pub. Date: Dec. 14, 2006

(54) AV network system and display device-side subsystem included in the same system

(75) Inventor: Masayoshi Matsuoka, Daito-Shi (JP)

Correspondence Address: CROWELL & MORING LLP;INTELLECTUAL PROPERTY GROUP, P.O. BOX 14300, WASHINGTON, DC, 20044-4300, US

(73) Assignee: Funai Electric Co., Ltd., Daito-shi (JP)

(21) Appl. No.: 11/451,462

(22) Filed: Jun. 13, 2006

(30) Foreign Application Priority Data
Jun. 14, 2005 (JP) 2005-173295

(51) Int. Cl. G09G 5/00

(52) U.S. Cl. 345/661

(57) ABSTRACT

An AV network system including a display device-side subsystem and a source device-side subsystem is provided. When detecting a user's finger placed on a touch panel of the display device, a microprocessor in the display device determines a position (current position) on the touch panel where the user's finger is currently placed and determines an area (selected area) corresponding to an item currently selected on an EPG displayed on a display of the source device. When the current position is not within the selected area, the microprocessor sends to a server a command corresponding to one of up, down, left, and right keys on a remote control for the source device until the current position becomes within the selected area. Accordingly, a user can make an intuitive selection of an item by touching the item to be selected among items in the EPG.

### BACKGROUND OF THE INVENTION

1. Field of the Invention

The present invention relates to an audio and visual (AV) network system where a display device-side subsystem including a display device having a touch panel is connected via a network to a source device-side subsystem including a video/audio signal output device (hereinafter, referred to as “source device”) such as a set-top box (STB).

2. Description of the Related Art

Audio and visual (AV) network systems are known where a display device-side subsystem including a display device having a touch panel and information equipment as a client (hereinafter referred to simply as “client”) connected to the display device is connected via a network to a source device-side subsystem including a source device such as a STB, a DVD player, a HDD recorder, or the like and information equipment as a server (hereinafter referred to simply as “server”) connected to the source device. When controlling the source device by using the display device in this kind of a network system, a simulator of a remote control (hereinafter referred to as “remote-control simulator”) for controlling the source device is displayed on the touch panel so that a user can touch a key on the remote-control simulator for control of the source device.

In the above described control method, a control code corresponding to a key on the remote-control simulator is sent from the client to the server. Thereby, the source device performs an operation corresponding to the control code. In the case where the source device contains an internal network interface circuit functioning as the server (i.e., where the server is built into the source device), information on the content of the control code is sent via the network interface circuit to a microprocessor in the source device. Then, the microprocessor in the source device performs the operation corresponding to the control code. In the case where information equipment functioning as the server is external to the source device (i.e., where the server is not built into the source device), an infrared radiation (IR) blaster is connected to the server. In this case, the control code corresponding to a key on the remote-control simulator is converted to an IR code for the source device. The IR code is then sent in the form of infrared signals to the source device via the IR blaster from the server. In response, the microprocessor of the source device performs the operation corresponding to the above control code.

However, the above described method for controlling the source device by using keys on the remote-control simulator has the following problem. When a GUI in list form such as an electronic program guide (EPG) or the like is displayed on the screen of the display device, the above method only allows a user to use up/down and left/right keys and an enter key on the remote-control simulator for selection of a desired item among items in the list. A user is not allowed to select an item by touching the item among items in the list shown on the GUI. In other words, a user cannot make an intuitive selection.

A conceivable way to make intuitive selections is to select an item by touching the item among items in a list displayed on the touch panel. In order to ensure a selection in such a way, it is necessary that a currently selected item match an item currently touched by a user on the touch panel of the display device before the user confirms the selection. However, where a display device and a source device supplied by different vendors are used, the display device side fails to keep up on an item being selected on the source device side because data sent from the source device side to the display device side is only video and audio data. Therefore, the display device-side subsystem cannot automatically cause an item currently selected on the source device side to match an item on the touch panel of the display device that is currently touched by a user. Accordingly, the currently selected item cannot be matched to the item currently touched by the user on the touch panel of the display device when the user confirms the selection. In other words, a reliable selection cannot be achieved.

### SUMMARY OF THE INVENTION

An object of the present invention is to provide an AV network system and a display device-side subsystem included in the same system that allow a user to make an intuitive selection of an item by touching the item to be selected among items in a list displayed on a touch panel and that allow the selection to be reliably performed.

According to a first aspect of the present invention, this object is achieved by an audio and visual (AV) network system where a display device-side subsystem including a display device having a touch panel is connected via a network to a source device-side subsystem including a video/audio signal output device (hereinafter referred to as “source device”).

The source device comprises display means for displaying a GUI in list form.

The display device-side subsystem comprises: current position determining means for determining a position (hereinafter referred to as “current position”) on the touch panel where a user's finger is currently placed; selected area determining means for determining an area (hereinafter referred to as “selected area”) corresponding to an item currently selected on the GUI in list form displayed on a display of the source device; determination means for determining whether or not the current position determined by the current position determining means is within the selected area determined by the selected area determining means; move command sending control means for, when it is determined by the determination means that the current position is not within the selected area, controlling sending, to the source device-side subsystem, of a command corresponding to one of up, down, left, and right keys on a remote control for the source device until the current position becomes within the selected area; and enter command sending control means for controlling sending, to the source device, of a command corresponding to an enter key on the remote control for the source device when the current position is within the selected area as a result of the sending of the command by the move command sending control means and a user confirms selection of an item (selected item) corresponding to the selected area.

With the above configuration, when a user's finger placed on the touch panel is detected, a command corresponding to one of the up, down, left, and right keys on the source device remote control is repeatedly sent to the server until the current position becomes within the selected area. A command corresponding to the enter key on the source device remote control is sent to the server only when the current position is within the selected area as a result of the sending of the above command and a user confirms the selection of the selected item. Accordingly, an intuitive selection of an item can be made by touching the item to be selected among items in a list displayed on the touch panel. Further, the selection can be reliably performed by causing the currently selected item to match the item currently touched by the user on the touch panel of the display device before the user confirms the selection.

Preferably, the selected area determining means sends, to the source device-side subsystem, a command corresponding to one of the up, down, left, and right keys on the remote control for the source device so as to cause a change in the GUI in list form displayed on the display of the source device, and compares the GUI displayed before the change with the GUI displayed after the change so as to determine the selected area in the GUI displayed before the change and handle the determined selected area as a current selected area.

Further preferably, the GUI in list form is an EPG.

According to a second aspect of the present invention, the object is achieved by an audio and visual (AV) network system where a display device-side subsystem is connected via a network to a source device-side subsystem, the display device-side subsystem including a display device having a touch panel and a PC as a client (hereinafter referred to simply as “client”) connected to the display device, the source device-side subsystem including a video/audio signal output device (hereinafter referred to as “source device”) and a PC as a server (hereinafter referred to simply as “server”) connected to the source device.

The server is connected to an infrared radiation (IR) blaster for transmitting to the source device an infrared signal corresponding to a control code sent from the client.

The source device comprises: infrared receiver means for receiving the infrared signal transmitted from the IR blaster; and display means for displaying a GUI in list form.

The client comprises: detection means for detecting a user's finger placed on the touch panel; current position determining means for, when the detection means detects the user's finger placed on the touch panel, determining a position (hereinafter referred to as “current position”) on the touch panel where the user's finger is currently placed; selected area determining means for, when the detection means detects the user's finger placed on the touch panel, determining an area (hereinafter referred to as “selected area”) corresponding to an item currently selected in the GUI in list form displayed on a display of the source device; determination means for determining whether or not the current position determined by the current position determining means is within the selected area determined by the selected area determining means; move command sending control means for, when it is determined by the determination means that the current position is not within the selected area, controlling sending, to the server, of a command corresponding to one of up, down, left, and right keys on a remote control for the source device until the current position becomes within the selected area; and enter command sending control means for controlling sending, to the server, of a command corresponding to an enter key on the remote control for the source device when the current position is within the selected area as a result of the sending of the command by the move command sending control means and the user moves the finger off the touch panel and places the finger on the touch panel again within two seconds.

The selected area determining means: sends to the server a command corresponding to one of the up, down, left, and right keys on the source device remote control for cursor movement in a first direction so as to cause a change in the GUI in list form displayed on the display of the source device, and compares the GUI displayed before the change with the GUI displayed after the change so as to determine the selected area in the GUI displayed before the change and handle the determined selected area as a current selected area; and subsequently sends, to the source device-side subsystem, a command corresponding to one of the up, down, left, and right keys for cursor movement in a second direction opposite to the first direction so as to restore the GUI in list form displayed on the display of the source device to the display before the change.

The above configuration allows a user to make an intuitive selection of an item by touching the item among items in a list displayed on the touch panel.

Further, the client sends to the server a command corresponding to one of the up, down, left, and right keys on the remote control for the source device so as to cause a change in the GUI in list form displayed on the display of the source device. The client then compares the GUI displayed before the change with the GUI displayed after the change so as to determine the selected area (area corresponding to a currently selected item) in the GUI displayed before the change and handle the determined selected area as the current selected area. This allows the client to keep up on an item currently selected on the source device side so as to automatically cause the currently selected item to match an item on the touch panel of the display device that is currently touched by a user. Accordingly the currently selected item can be matched to the item currently touched by the user on the touch panel of the display device before the user confirms the selection. In other words, a reliable (two-step) selection can be performed.

According to a third aspect of the present invention, the object is achieved by a display device-side subsystem connected via a network to a source device-side subsystem including a video/audio signal output device (hereinafter referred to as “source device”).

The display device-side subsystem comprises: a display device having a touch panel; current position determining means for determining a position (hereinafter referred to as “current position”) on the touch panel where a user's finger is currently placed; selected area determining means for determining an area (hereinafter referred to as “selected area”) corresponding to an item currently selected on a GUI in list form displayed on a display of the source device; determination means for determining whether or not the current position determined by the current position determining means is within the selected area determined by the selected area determining means; move command sending control means for, when it is determined by the determination means that the current position is not within the selected area, controlling sending, to the source device-side subsystem, of a command corresponding to one of up, down, left, and right keys on a remote control for the source device until the current position becomes within the selected area; and enter command sending control means for controlling sending, to the source device, of a command corresponding to an enter key on the remote control for the source device when the current position is within the selected area as a result of the sending of the command by the move command sending control means and a user confirms selection of an item (selected item) corresponding to the selected area.

While the novel features of the present invention are set forth in the appended claims, the present invention will be better understood from the following detailed description taken in conjunction with the drawings.

### BRIEF DESCRIPTION OF THE DRAWINGS

The present invention will be described hereinafter with reference to the annexed drawings. It is to be noted that all the drawings are shown for the purpose of illustrating the technical concept of the present invention or embodiments thereof, wherein:

FIG. 1 is a schematic block diagram of an AV network system according to an embodiment of the present invention;

FIG. 2 shows an example of a screen displayed on the touch panel in FIG, 1;

FIG. 3 is a flowchart showing an item selection process that is performed by the client in the AV network system;

FIG. 4 shows an example of an EPG displayed on the display of the source device in the AV network system; and

FIG. 5 shows an example of an EPG displayed on the display of the source device in the AV network system.

### DESCRIPTION OF THE PREFERRED EMBODIMENTS

Referring now to the accompanying drawings, a preferred embodiment of the present invention is described. The present invention relates to an audio and visual (AV) network system where a display device-side subsystem including a display device having a touch panel is connected via a network to a source device-side subsystem including a video/audio signal output device (hereinafter referred to as “source device”) such as a set-top box (STB). It is to be noted that the following description of preferred embodiment of the present invention has been presented for purposes of illustration and description, and is not intended to be exhaustive or to limit the present invention to the precise form disclosed.

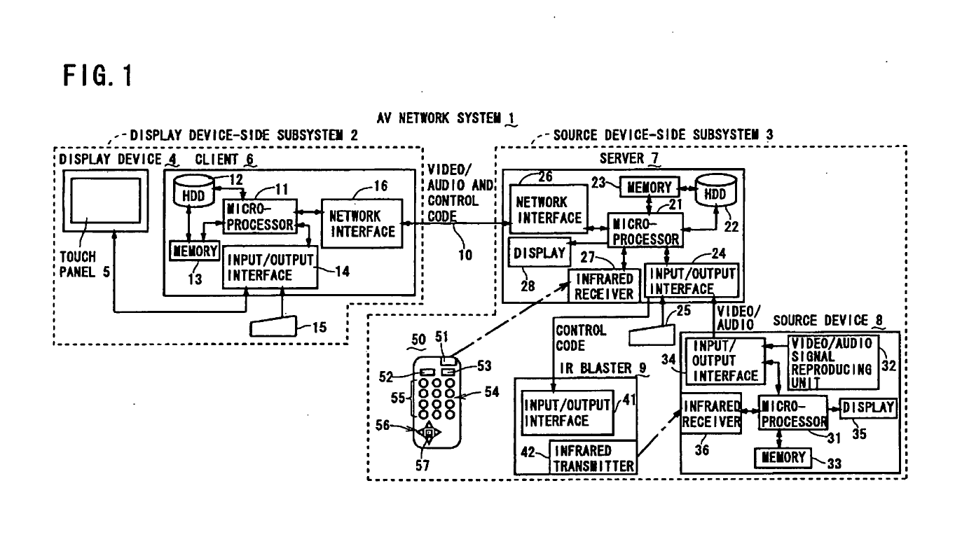

FIG. 1 shows an AV network system according to this embodiment. The AV network system 1 is a system where a display device-side subsystem 2 and a source device-side subsystem 3 are connected to each other via a communication channel 10 (network). The display device-side subsystem 2 comprises: a display device 4 having a touch panel 5; and a PC as a client (hereinafter referred to simply as “client”) 6 that is connected to the display device 4. The source device-side subsystem 3 comprises: a video/audio signal output device (hereinafter referred to as “source device”) 8 such as a set-top box (STB), a DVD player, a HDD recorder, or the like; a PC as a server (hereinafter referred to simply as “server”) 7 that is connected to the source device 8; and an infrared radiation (IR) blaster 9 connected to the server 7. The IR blaster 9 is essentially an extension cable with a transmitter that is used with a remote control 50 for the server 7, but it can transmit to the source device 8 an infrared signal corresponding to a control code sent from the client 6.

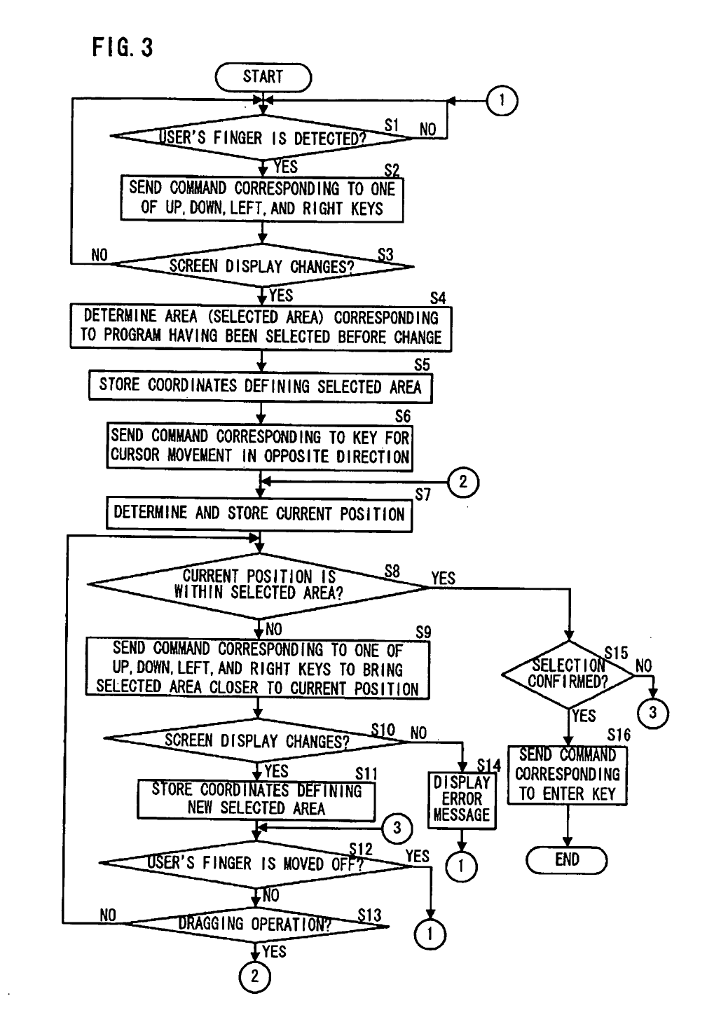

The client 6 has: a microprocessor 11 to control each component in the client; a HDD 12 to store various kinds of data and various kinds of control programs including a program for an item selection process shown in the flowchart of FIG. 3; a memory 13 to be loaded with the various kinds of control programs and to temporarily store GUI image data sent from the source device 8; an input/output interface 14 to send and receive data to and from the display device 4 and receive data entered via a keyboard 15; and a network interface 16 to receive video and audio signals from the server 7 and send a control code to the server 7 via the communication channel 10. The keyboard 15 is connected to the client 6. The microprocessor 11 serves as claimed detection means, current position determining means, selected area determining means, determination means, move command sending control means, and enter command sending control means.

The server 7 has: a microprocessor 21 to control each component in the server 7; a HDD 22 to store various kinds of control programs and various kinds of data; a memory 23 to be loaded with the various kinds of control programs for example; an input/output interface 24 to send a control code to the IR blaster 9 and receive video and audio signals (composite signal) from the source device 8; a network interface 26 to send video and audio signals to the client 6 and receive a control code from the client 6 via the communication channel 10; an infrared receiver 27 to receive an infrared signal transmitted from the remote control 50; and a display 28. The server 7 is connected to a key board 25.

The remote control 50 for the server 7 has an infrared transmitter 51 and a key portion 54, where arranged are various keys such as a power key 53, numeric keys 55, cursor-movement keys 56, an enter key 57, and a menu key 52 for causing various menus to be displayed.

The source device 8 has: a microprocessor 31 to control each component in the device; video/audio signal reproducing unit 32 to reproduce video and audio signals; a memory 33 to be loaded with various kinds of control programs for example; an input/output interface 34 to send video and audio signals (composite signal) to the server 7; a display 35 (display means) to display, for example, a GUI in list form such as an EPG; and an infrared receiver 36 (infrared receiver means) to receive an infrared signal transmitted from the IR bluster 9 for example.

The IR blaster 9 connected to the server 7 has: an input/output interface 41 to receive a control code from the server 7; and an infrared transmitter 42.

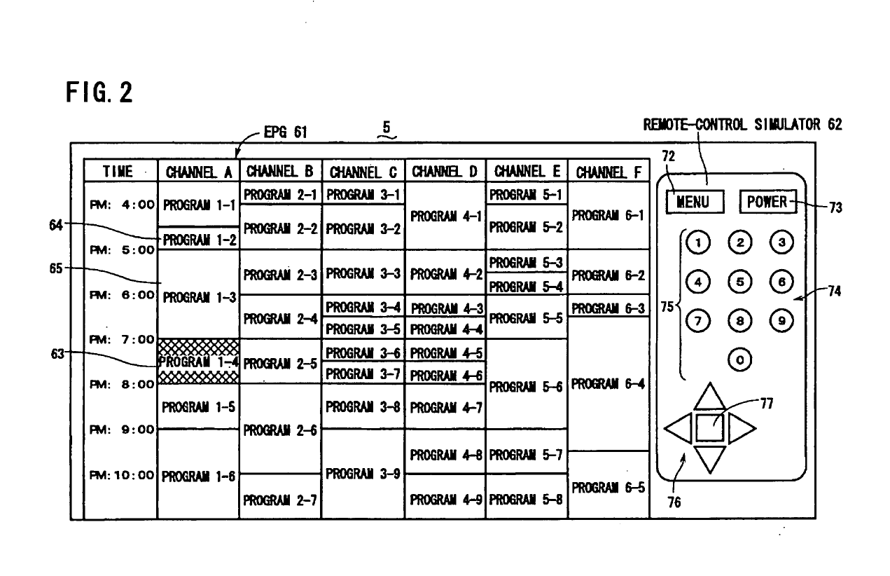

FIG. 2 shows an example of a screen displayed on the touch panel 5 of the display device 4. Just after the AV network system 1 is started up, the touch panel 5 displays a remote-control simulator 62 for controlling the source device 8 together with a video image sent from the source device 8. In this state, when a user selects a program selection process by using a menu key 72, cursor-movement keys 76, and an enter key 77 on the remote-control simulator 62, the client 6 sends a command to display an EPG, which is a GUI in list form, via the server 7 and the IR blaster 9 to the source device 8. Upon receipt of the command, the source device 8 displays an EPG on the display 35 thereof and displays an EPG 61 as shown in FIG. 2 on the touch panel 5 of the display device 4 via the server 7 and the client 6. This allows the user to intuitively and easily select a desired program (item) by touching the program in the displayed EPG 61.

FIG. 3 is a flowchart showing the process of an item selection program that is started when a user selects a desired item from among items displayed on the EPG 61 or other GUI in list form. The process starts when the microprocessor 11 of the client 6 detects a user's finger placed on the touch panel 5 (YES at S1). Then, the microprocessor 11 determines an area (hereinafter, referred to as “selected area”) corresponding to an item currently selected in the GUI in list form being displayed on the display 35 of the source device 8 and on the touch panel 5 of the display device 4. For example, when the GUI in list form is an EPG as shown in FIG. 2, the microprocessor 11 of the client 6 determines an area corresponding to a program currently selected in the EPG. The microprocessor 11 performs the above determination of selected area by finding an area on the touch panel 5 that is polygonal (particularly, rectangular) or circular and different in color from its surrounding areas on the touch panel 5.

More particularly, the microprocessor 11 of the client 6 sends a command corresponding to one of up, down, left, and right keys on a remote control (not shown) for the source device 8, via the server 7 and the IR blaster 9 to the source device 8 (S2). If this results in a change in the screen displays on the display 35 of the source device 8 and on the touch panel 5 of the display device 4 (YES at S3), it is determined that the screen displayed on the touch panel 5 is a kind of a GUI in list form that allows a user to select an item within the screen. Accordingly, microprocessor 11 compares the GUI displayed before the change with the GUI displayed after the change so as to determine the selected area (coordinates) in the GUI displayed before the change (S4). Then, the microprocessor 11 stores the determined selected area as a current selected area in the memory 13 (S5).

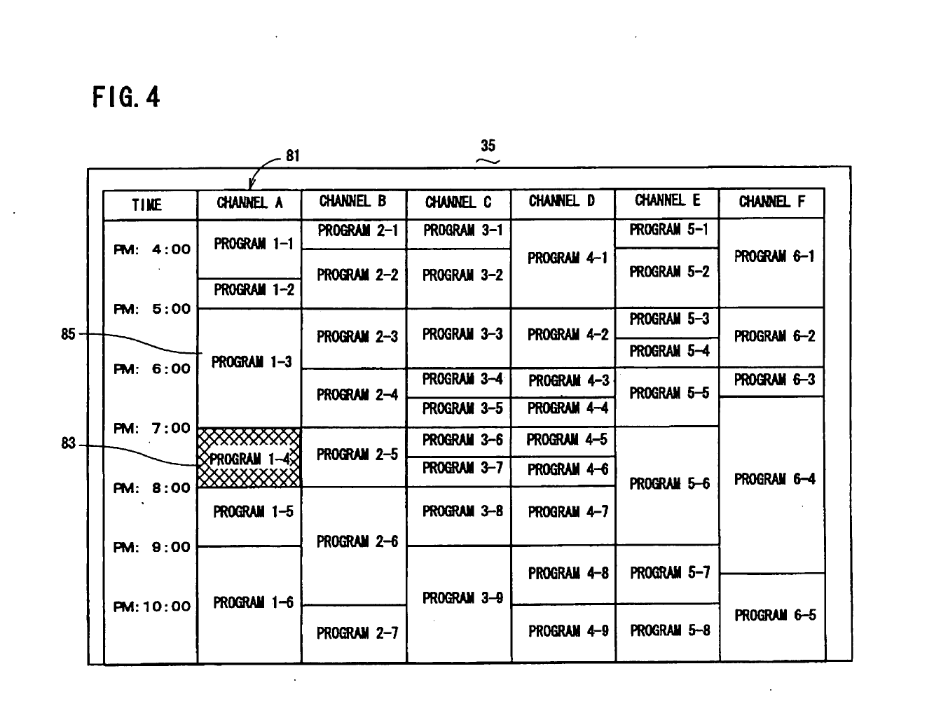

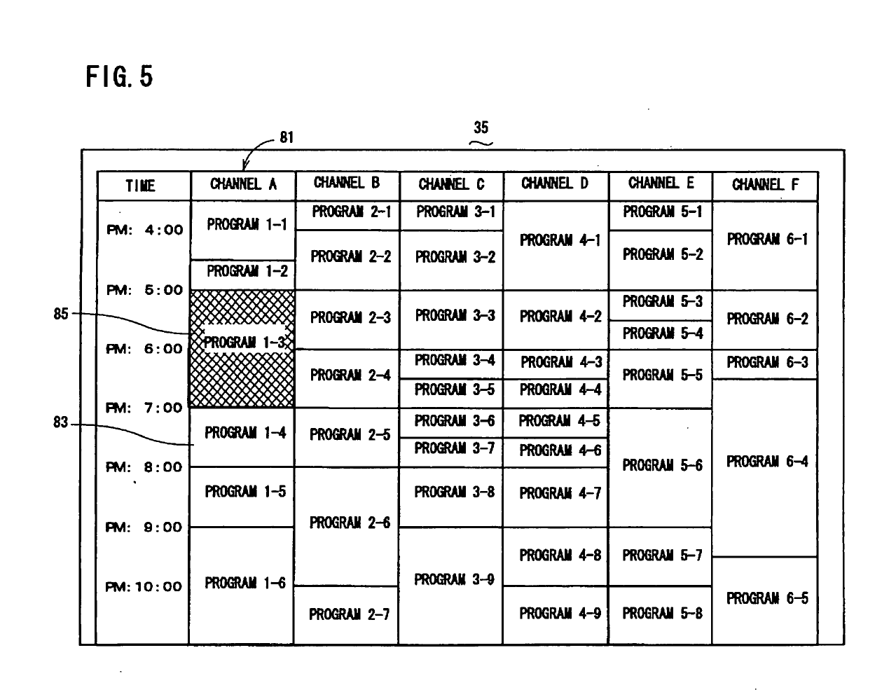

For example, when the GUI in list form is the EPG as shown in FIG. 2, the microprocessor 11 of the client 6 sends a command corresponding to one of the up, down, left, and right keys on the remote control for the source device 8 via the server 7 and the IR blaster 9 to the source device 8, whereby the microprocessor 11 causes a change in the EPG 81 displayed on the display 35 of the source device 8 (see FIGS. 4 and 5). Then, the microprocessor 11 receives image data representing the EPG 81 displayed after the change (see FIG. 5) and image data representing the EPG 81 displayed before the change (see FIG. 4). The microprocessor 11 of the client 6 stores the received image data representing the EPG before and after the change in the memory 13, but keeps the EPG 61 before the change, which is shown in FIG. 2, displayed on the touch panel 5 even after receiving the image data representing the EPG after the change. The microprocessor 11 compares the stored image data representing the EPG before the change with the stored image data representing the EPG after the change so as to determine the area (selected area) corresponding to a program (program 63 in FIG. 2 and program 83 in FIG. 4) having been selected in the EPG before the change and store the determined selected area (coordinates) as a current selected area in the memory 13 (S5).

After the above step S5, the microprocessor 11 of the client 6 sends a command corresponding to one of the up, down, left, and right keys for cursor movement in a direction opposite to that of the key used at the above step S2, via the server 7 and the IR blaster 9 to the source device 8, so as to change the area (selected area) corresponding to a program currently selected on the source device 8 side back to the area corresponding to the program (program 83 in FIG. 4) having been selected before the change (S6). Thereby, the microprocessor 11 restores the EPG 81 on the display 35 of the source device 8 to the display before the change (i.e., to the display shown in FIG. 4).

Subsequently, the microprocessor 11 of the client 6 determines a position (hereinafter referred to as “current position”) on the touch panel 5 where the user's finger is currently placed, and stores the current position in the memory 13 (S7). The microprocessor 11 then determines whether or not the current position is within the selected area (area corresponding to a currently selected item (for example, the program 63 in FIG. 2)) determined at the above step S5 (S8). If finding that the current position is not within the selected area as a result of the determination at the step S8 (NO at S8), the microprocessor 11 of the client 6 sends a command corresponding to one of the up, down, left, and right keys, via the server 7 and the IR blaster 9 to the source device 8, so that the selected area on the EPG changes from the current selected area (e.g., the area corresponding to the program 63 in FIG. 2) to an area closer to the current position (position where the user's finger is currently placed) (S9). For example, when the currently selected item is the program 63 in FIG. 2 and the current position is a position on the area corresponding to a program 64 in FIG. 2, the microprocessor 11 of the client 6 sends a command corresponding to the up key so as to bring the selected area closer to the current position, via the server 7 and the IR blaster 9 to the source device 8.

If the GUI screen, e.g. the EPG 61, displayed on the touch panel 5 changes as a result of the sending of the command at the above step S9 (YES at S10), the microprocessor 11 of the client 6 stores the coordinates defining an area newly selected in the GUI screen after the change (e.g., the area corresponding to a program 65 in FIG. 2) as a new selected area in the memory 13 (S11). Otherwise, if the screen display does not change even after the command sending at the step S9 is repeated several times (NO at S10), the microprocessor 11 displays an error message on the touch panel 5 (S14) and returns to the above step S1. If the user moves the finger off the touch panel 5 after the step S11 (YES at S12), the microprocessor 11 also returns to the step S1. If it is found as a result of the determination at the step S12 that the user's finger is still on the touch panel 5 (NO at S12), and further if the user performs a dragging operation on the touch panel 5 (i.e., if the microprocessor 11 detects a movement of the user's finger on the touch panel 5) (YES at S13), the microprocessor 11 returns to the above step S7. If the user does not perform a dragging operation on the touch panel 5 (i.e., if the microprocessor 11 detects no movement of the user's finger on the touch panel 5) (NO at S13), the microprocessor 11 returns to the above step S8.

If the current position becomes within the above described new selected area as a result of repeated command sending at the step S9 (YES at S8) and, in this state, the user moves the finger off the touch panel 5 and then places the finger on the touch panel 5 again within two seconds (confirms the selection) (YES at S15), the microprocessor 11 of the client 6 sends to the server 7 a command corresponding to the enter key on the remote control for the source device 8 (S16). Otherwise, if the user does not confirm the selection in the above described manner within two seconds (No at S15), the microprocessor 11 of the client 6 returns to the above step S12.

As described above, the AV network system 1 of this embodiment allows a user to make an intuitive selection of an item by touching the item among items in a list (e.g., among programs in the EPG 61) displayed on the touch panel 5.

Further, the client 6 sends to the server 7 a command corresponding to one of the up, down, left, and right keys on the remote control for the source device 8 so as to cause a change in a GUI in list form (e.g., the EPG 81) displayed on the display 35 of the source device 8. The client 6 then compares the GUI displayed before the change with the GUI displayed after the change so as to determine the selected area (area corresponding to a currently selected item) in the GUI displayed before the change and store the determined selected area as a current selected area. This allows the client 6 to keep up on an item currently selected on the source device 8 side so as to automatically cause the currently selected item to match an item currently touched by a user on the touch panel 5 of the display device 4. Accordingly, the currently selected item can be matched to the item currently touched by the user on the touch panel 5 of the display device 4 before the user confirms the selection. In other words, a reliable (two-step) selection can be performed.

The present invention has been described above using a presently preferred embodiment, but those skilled in the art will appreciate that various modifications are possible. For example, the display device 4 and the client 6 are separate in the above described embodiment, but a display device having a communication function can also be used. In such a case, the display device-side subsystem comprises only the display device. Likewise, by configuring a source device to have a communication function, a source device-side subsystem comprising only the source device can be provided. This configuration allows a display device or a client to directly control the source device, which can eliminate the use of an IR blaster. GUIs in list form other than EPGs can also be improved in operability by the application of the present invention. Further, the selected area is determined based on colors in the above described embodiment, but it can be determined based on brightness or the like.

This application is based on Japanese patent application 2005-173295 filed Jun. 14, 2005, the contents of which are hereby incorporated by reference.

What is claimed is:

1. An audio and visual (AV) network system where a display device-side subsystem including a display device having a touch panel is connected via a network to a source device-side subsystem including a video/audio signal output device (hereinafter referred to as “source device”),
wherein the source device comprises display means for displaying a GUI in list form, and
wherein the display device-side subsystem comprises:
current position determining means for determining a position (hereinafter referred to as “current position”) on the touch panel where a user's finger is currently placed;
selected area determining means for determining an area (hereinafter referred to as “selected area”) corresponding to an item currently selected on the GUI in list form displayed on a display of the source device;
determination means for determining whether or not the current position determined by the current position determining means is within the selected area determined by the selected area determining means;
move command sending control means for, when it is determined by the determination means that the current position is not within the selected area, controlling sending, to the source device-side subsystem, of a command corresponding to one of up, down, left, and right keys on a remote control for the source device until the current position becomes within the selected area; and
enter command sending control means for controlling sending, to the source device, of a command corresponding to an enter key on the remote control for the source device when the current position is within the selected area as a result of the sending of the command by the move command sending control means and a user confirms selection of an item (selected item) corresponding to the selected area.

2. The AV network system according to claim 1,
wherein the selected area determining means sends, to the source device-side subsystem, a command corresponding to one of the up, down, left, and right keys on the remote control for the source device so as to cause a change in the GUI in list form displayed on the display of the source device, and compares the GUI displayed before the change with the GUI displayed after the change so as to determine the selected area in the GUI displayed before the change and handle the determined selected area as a current selected area.

3. The AV network system according to claim 2,
wherein the GUI in list form is an EPG.

4. The AV network system according to claim 1,
wherein the GUI in list form is an EPG.

5. An audio and visual (AV) network system where a display device-side subsystem is connected via a network to a source device-side subsystem, the display device-side subsystem including a display device having a touch panel and a PC as a client (hereinafter referred to simply as “client”) connected to the display device, the source device-side subsystem including a video/audio signal output device (hereinafter referred to as “source device”) and a PC as a server (hereinafter referred to simply as “server”) connected to the source device,
wherein the server is connected to an infrared radiation (IR) blaster for transmitting to the source device an infrared signal corresponding to a control code sent from the client,
wherein the source device comprises: infrared receiver means for receiving the infrared signal transmitted from the IR blaster; and display means for displaying a GUI in list form,
wherein the client comprises:
detection means for detecting a user's finger placed on the touch panel;
current position determining means for, when the detection means detects the user's finger placed on the touch panel, determining a position (hereinafter referred to as “current position”) on the touch panel where the user's finger is currently placed;
selected area determining means for, when the detection means detects the user's finger placed on the touch panel, determining an area (hereinafter referred to as “selected area”) corresponding to an item currently selected in the GUI in list form displayed on a display of the source device;
determination means for determining whether or not the current position determined by the current position determining means is within the selected area determined by the selected area determining means;
move command sending control means for, when it is determined by the determination means that the current position is not within the selected area, controlling sending, to the server, of a command corresponding to one of up, down, left, and right keys on a remote control for the source device until the current position becomes within the selected area; and
enter command sending control means for controlling sending, to the server, of a command corresponding to an enter key on the remote control for the source device when the current position is within the selected area as a result of the sending of the command by the move command sending control means and the user moves the finger off the touch panel and places the finger on the touch panel again within two seconds,
wherein the selected area determining means: sends to the server a command corresponding to one of the up, down, left, and right keys on the source device remote control for cursor movement in a first direction so as to cause a change in the GUI in list form displayed on the display of the source device, and compares the GUI displayed before the change with the GUI displayed after the change so as to determine the selected area in the GUI displayed before the change and handle the determined selected area as a current selected area; and
subsequently sends, to the source device-side subsystem, a command corresponding to one of the up, down, left, and right keys for cursor movement in a second direction opposite to the first direction so as to restore the GUI in list form displayed on the display of the source device to the display before the change.

6. The AV network system according to claim 5,
wherein the GUI in list form is an EPG.

7. A display device-side subsystem connected via a network to a source device-side subsystem including a video/audio signal output device (hereinafter referred to as “source device”), comprising:
a display device having a touch panel;
current position determining means for determining a position (hereinafter referred to as “current position”) on the touch panel where a user's finger is currently placed;
selected area determining means for determining an area (hereinafter referred to as “selected area”) corresponding to an item currently selected on a GUI in list form displayed on a display of the source device;
determination means for determining whether or not the current position determined by the current position determining means is within the selected area determined by the selected area determining means;
move command sending control means for, when it is determined by the determination means that the current position is not within the selected area, controlling sending, to the source device-side subsystem, of a command corresponding to one of up, down, left, and right keys on a remote control for the source device until the current position becomes within the selected area; and
enter command sending control means for controlling sending, to the source device, of a command corresponding to an enter key on the remote control for the source device when the current position is within the selected area as a result of the sending of the command by the move command sending control means and a user confirms selection of an item (selected item) corresponding to the selected area.

8. The display device-side subsystem according to claim 7,
wherein the selected area determining means sends, to the source device-side subsystem, a command corresponding to one of the up, down, left, and right keys on the remote control for the source device so as to cause a change in the GUI in list form displayed on the display of the source device, and compares the GUI displayed before the change with the GUI displayed after the change so as to determine the selected area in the GUI displayed before the change and handle the determined selected area as a current selected area.

9. The display device-side subsystem according to claim 8,
wherein the GUI in list form is an EPG.

10. The display device-side subsystem according to claim 7,
wherein the GUI in list form is an EPG.
